(19) United States
(12) Patent Application Publication
(10) Pub. No.: US 2022/0280016 A1
(43) Pub. Date: Sep. 8, 2022

(54) Flexible Scrubber Tool with Abrader

(71) Applicant: 21imports LLC, Lakewood, NJ (US)

(72) Inventor: Dov Kurlander, Lakewood, NJ (US)

(73) Assignee: 21imports LLC, Lakewood, NJ (US)

(21) Appl. No.: 17/575,012

(22) Filed: Jan. 13, 2022

Related U.S. Application Data
(60) Provisional application No. 63/136,679, filed on Jan. 13, 2021.

(51) Int. Cl. A47L 17/08

(52) U.S. Cl. CPC A47L 17/08

(57) ABSTRACT

A flexible scrubbing tool with abrader includes a scrubber body and an abrader. The scrubber body may be composed of a scrubber base positioned beneath a shaft, middle handle, and top handle. The scrubber base contains a plurality of base channels, extending vertically through the scrubber base. The abrader may be composed of a planar, networked pattern of metal rings linked to one another to create a flexible sheet. The abrader is draped around the scrubber base and secured via an abrader ring to prevent the abrader from detachment.

### RELATED APPLICATION

This application claims priority to and incorporates entirely by reference U.S. Provisional Patent Application Ser. No. 63/136,679 filed on Jan. 13, 2021.

### FIELD OF THE INVENTION

This invention relates to scrubbing tools and, more particularly, to a flexible scrubbing tool with an attached metal abrader component. The scrubbing tool contains vertical channels, allowing it to be compressed and/or flexed to fit the contours of the item to be cleaned.

### BACKGROUND OF THE INVENTION

Scrubbing tools, including brushes, sponges, abraders, and cloths, are widely used in applications varying from home or commercial kitchens to professional janitorial/maintenance services. Such implements are well known in the art for use in, for example, cleaning foodservice dishes, kitchen environments, or in general household or commercial cleaning uses.

In the kitchen or foodservice environment, cast iron cookware has remained a popular and unique form of cookware since its introduction hundreds of years ago. Cast iron cookware has recently experienced a resurgence in popularity, led primarily through cooking shows and popularity in specialty markets.

One unique advantage of cast iron as a cookware is the ability to “season” the cookware, in which a layer of animal fat or vegetable oil is cooked onto the surface of the cast iron cookware. The seasoning process creates a stick-resistant coating created by polymerized oils and fats, which may ease in cooking certain kinds of dishes or ingredients. Similarly, the cast iron seasoning may protect the cookware from rusting, reduce food interaction with the iron content of the cookware, and may impart unique flavor profiles.

Because of the nature of the cast iron seasoning, many chefs, food writers, and other professionals advise that cast iron users should avoid using any kinds of soaps or detergents (including conventional dishwashers) for cleaning seasoned cast iron cookware, as such products are thought to remove or damage the seasoning. Accordingly, many food professionals advocate cleaning cast iron cookware by: wiping the cookware using a clean cloth, washing with hot water and a stiff brush, or scrubbing with coarse salt and a cloth.

More recently, consumers have begun using chainmail as a means to effectively clean cast iron cookware without damaging the seasoning. Specifically, many products currently offered comprise a small chainmail “cloth” that can be used in place of a normal dish cloth to clean cast iron cookware. Other similar products comprise a sponge or similar implement that is contained within chainmail wrapped around the sponge.

Such chainmail products provide an abrasive means for cleaning the hard, rough surface of cast iron cookware without the need for damaging soaps or detergents. Rather, the chainmail can be used by itself (dry), with water, or with a light detergent for cleaning cast iron.

These products, however, include particular drawbacks. For example, chainmail cloths do not provide an easily grippable surface by which a user may manipulate the chainmail. Similarly, the user is required to grip the chainmail directly, which may damage a user's skin and dirty a user's hands with food remnants or cooking oils and greases. While many chainmail cloths are dishwasher safe, the cloth-like nature of the product leads to difficulty in securing the cloth to a surface within the dishwasher to prevent it from, for example, falling into the drain or cleaning arm of the dishwasher if dislodged from its position during a wash cycle.

Products that employ a sponge encased in chainmail similarly require a user's skin to contact the chainmail, while requiring the cookware and the user's skin to also potentially contact the inner sponge, which may be filled with bacteria or other undesirable particles.

Therefore, there exists a need for an abrasive scrubbing tool with an ergonomic, flexible handle that allows a user to protect their hand from the chainmail and/or cleaning surface while providing a flexible support for the chainmail, allowing the chainmail to conform to the contours of the cookware to be cleaned.

### SUMMARY OF THE INVENTION

In accordance with one form of this invention, there is provided a scrubbing tool including a top handle, a shaft, a middle handle, and a scrubber base; the scrubber base forming a plurality of base channels, each base channel extending vertically through the scrubber base; and an abrader draped around the scrubber base and secured to the scrubber base using a first abrader ring to prevent the abrader from detachment for the scrubber.

In accordance with one form of this invention, there is provided a scrubbing tool including a top handle, a shaft, a middle handle, and a scrubber base; the scrubber base forming a plurality of base channels, each base channel extending vertically through the scrubber base; and an abrader draped around the scrubber base and secured via a first abrader ring located beneath the scrubber base and a second abrader ring located above the scrubber base, each of the first and second abrader rings being provided for preventing the abrader from detachment for the scrubber base.

In accordance with one form of this invention, there is provided a scrubbing tool including a top handle, a shaft, a middle handle, and a scrubber base; the scrubber base forming a plurality of base channels, each base channel being dimensioned as a hexagon and extending vertically through the scrubber base; an abrader draped around the scrubber base and secured via a first abrader ring located beneath the scrubber base and a second abrader ring located above the scrubber base, each of the first and second abrader rings being provided for preventing the abrader from detachment for the scrubber base; and wherein the scrubber base is formed from silicone.

### BRIEF DESCRIPTION OF THE DRAWINGS

For a fuller understanding of the nature of the present invention, reference should be made to the following detailed description, taken in conjunction with the accompanying drawings in which:

FIG. 1 is a perspective view of the scrubber body of a flexible scrubbing tool with abrader;

FIG. 2 is a perspective view of a flexible scrubbing tool with abrader;

FIG. 3 is a profile view of a scrubber body of a flexible scrubbing tool with abrader;

FIG. 4 is a profile view of a scrubber body of a flexible scrubbing tool with abrader;

FIG. 5 is a top view of a scrubber body of a flexible scrubbing tool with abrader;

FIG. 6 is an underside view of a scrubber body of a flexible scrubbing tool with abrader; and

FIG. 7 is an underside view of a flexible scrubbing tool with abrader.

Like reference numerals refer to like reference parts throughout the several views of the drawings.

### DETAILED DESCRIPTION

Referring to the several views of the drawings, a flexible scrubbing tool with abrader is shown and described herein and is generally indicated as 100.

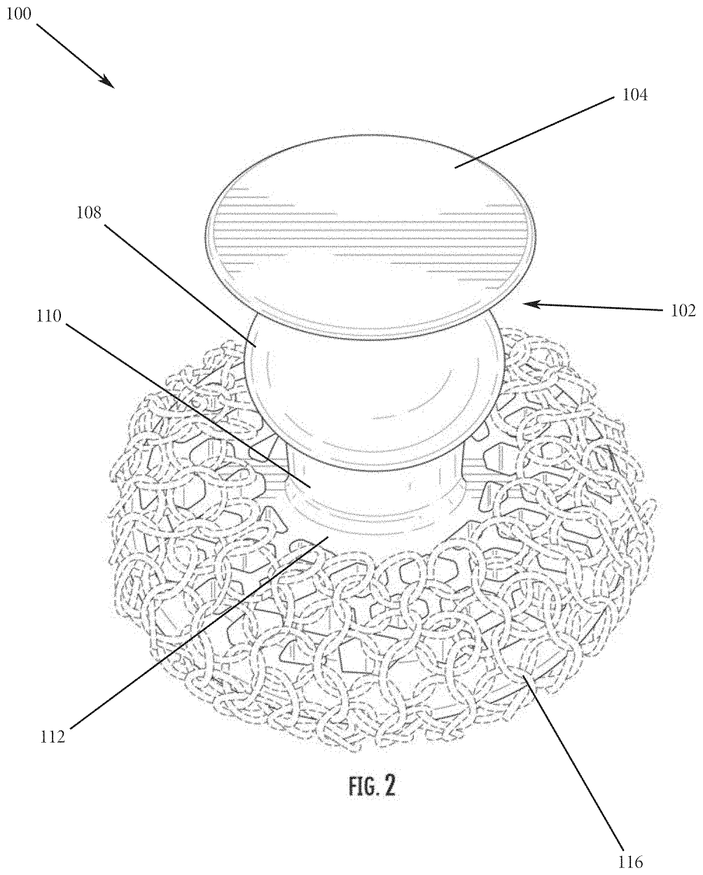

Referring initially to FIG. 2, the flexible scrubbing tool with abrader 100 is generally composed of a scrubber body 102 and an abrader 116.

In one embodiment, the scrubber body 102 is generally composed of a top handle 104, a top shaft 106, a middle grip 108, a bottom shaft 110, a scrubber base 112, and base channels 114. Attached to the scrubber body is the abrader 116, which may be constructed as a sheet of chainmail fitted around the scrubber base 112 and secured via an abrader ring 118.

In one embodiment, the scrubber body 102 is formed of solid silicone or a similarly flexible yet sturdy material that allows for ergonomic comfort, flexibility, and ease of cleaning. The scrubber body 102 may be formed of a single piece of material or a single molded material so as to increase durability and prevent multiple parts from breaking apart.

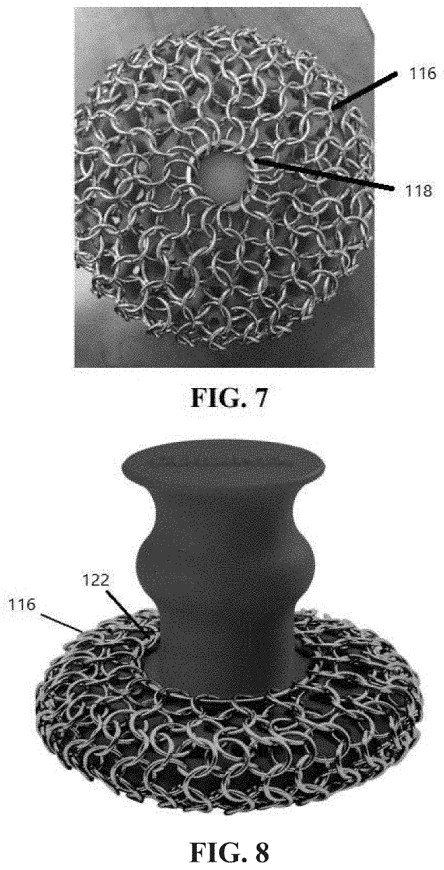

An embodiment of the chain mail abrader 116 is shown in FIGS. 2 and 7, and may be composed of a traditional chain pattern, in which small metal rings are attached to one another in a planar, networked pattern. The chain mail abrader, for example, is formed in a flexible sheet of chain mail that can bend along multiple axes and is draped around the scrubber base 112, where it is secured to the scrubber base 112 via an abrader ring 118, which prevents the sheet-like abrader 116 from detaching from the scrubber base 112. This embodiment allows the chain mail to retain the flexibility of its fabric-like nature, thus allowing it to conform to the surface of the cookware being cleaned as it is manipulated by the pressure applied from the scrubber body 102.

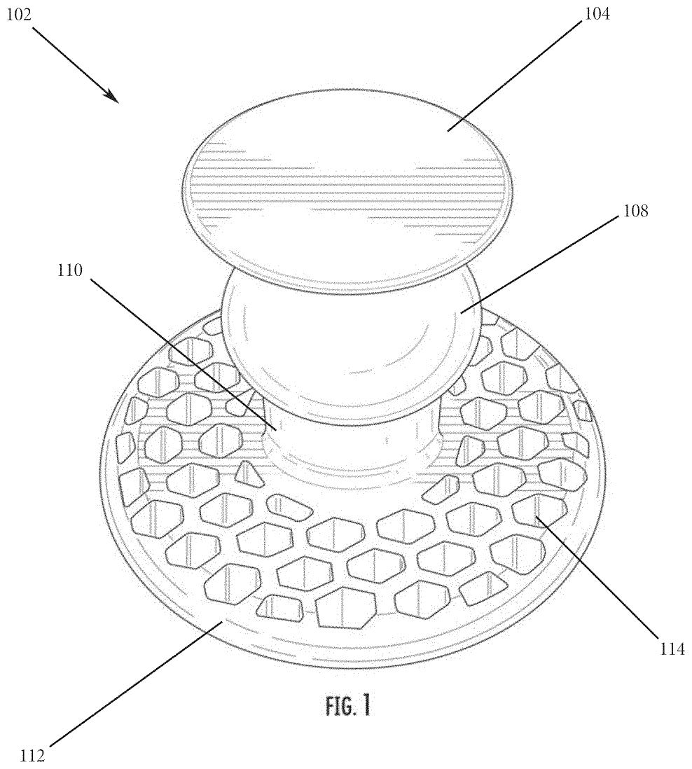

Referring now to FIGS. 1, 3 and 4, an embodiment of the flexible scrubbing tool with abrader 100 is shown. For convenience and clarity, the abrader 116 is not shown in FIGS. 1, 3, and 4. The top handle 104, in combination with the top shaft 106, middle grip 108, and bottom shaft 110, together provide an ergonomic handle by which a user may comfortably grip the flexible scrubbing tool with abrader 100 to apply pressure to the surface to be cleaned. It will be appreciated that the middle grip 108 may be located at a different vertical position along the shaft 120, and the top shaft 106 and bottom shaft 110 may be of varied respective lengths. Similarly, it will be appreciated that in an alternative embodiment, the middle grip 108 may be excluded such that the shaft 120 is one continuous, uniform component from the top handle 104 to the scrubber base 112. The top handle 104 may also be located at a sufficient height above the scrubber base 112 and abrader 116 so that a user's hand is located sufficiently above the abrader 116 to not touch the abrader 116 when in use.

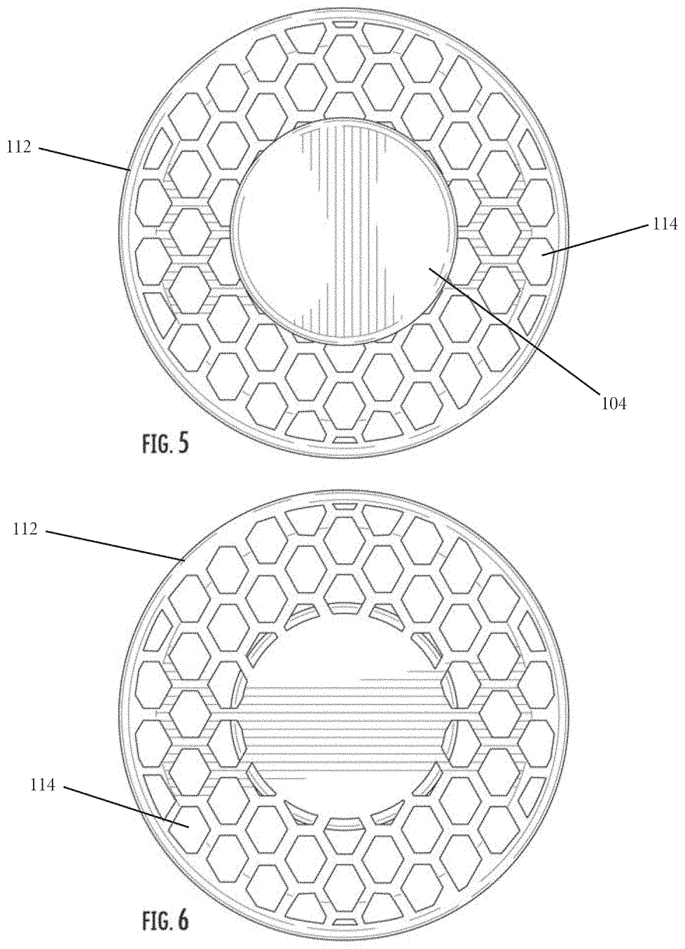

Referring now to FIG. 5, an embodiment of the flexible scrubbing tool with abrader 100 is depicted from a top view, showing the scrubber body 102. Referring to FIG. 6, an embodiment of the flexible scrubbing tool with abrader 100 is depicted from a bottom view, showing the scrubber base 112. For convenience and clarity, the abrader 116 is not shown in FIGS. 5-6. The scrubber base 112 contains a plurality of base channels 114 that are oriented vertically, extending through the scrubber base 112. The base channels 114 may be formed in the hexagonal shape as shown, or alternatively, may be formed in similar shapes such as circles, squares, or other polygonal forms.

The inclusion of base channels 114 in the scrubber base 112 decreases the overall density of the scrubber base 112, and thus increases the flexibility and deformability of the scrubber base 112. This flexibility and deformability are particularly present where the scrubber base 112 is silicone or a similarly durable and flexible material.

The base channels 114 may also allow for easier cleaning of the invention, particularly in the area between the abrader 116 and the underside of the scrubber base 112. Specifically, the base channels 114 allow water or other cleaning solvents to be dispersed to the interior side of the abrader 116 where dirt, grime, or other undesirable substances may otherwise accumulate.

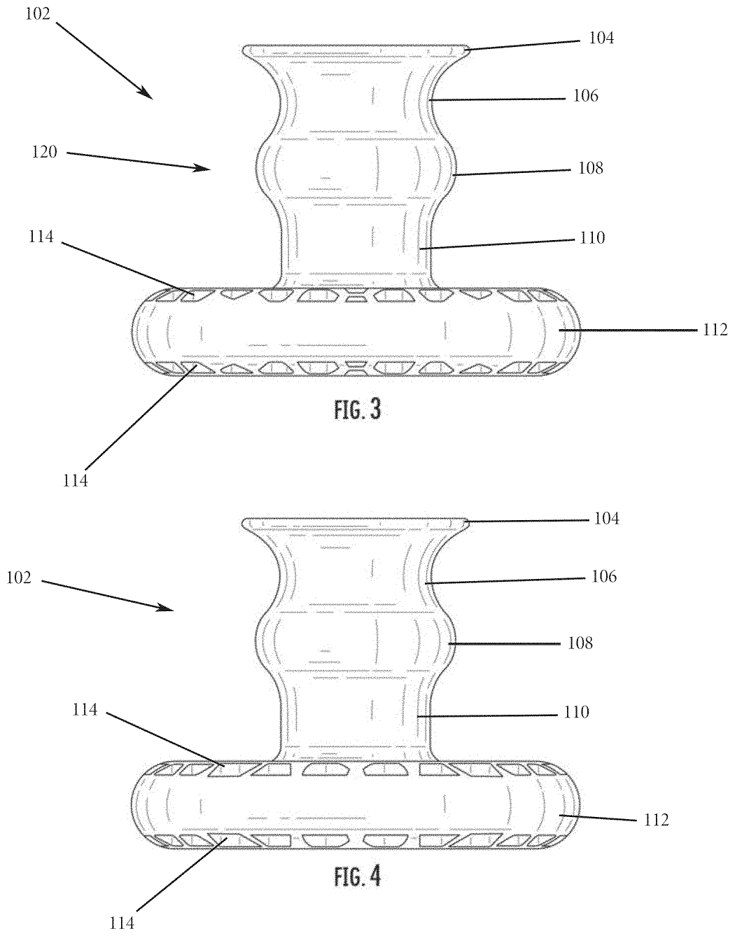

In one embodiment, the base channels 114 may be of varying shapes and diameters in order to allow for different points of flexion and for different amounts of flexion at different points in the scrubber body 102. The varying shapes and diameters result in different material densities at different portions of the scrubber base 112, and thus result in areas of the scrubber base 112 that are stiffer (or alternatively, more flexible) than other points in the scrubber base 112. For example, and as shown in FIGS. 3 and 4, base channels 114 are of different shapes, sizes, and/or diameters based upon their radial location around the scrubber base 112. These properties allow the scrubber body 102 and scrubber base 112 to flex to conform to the shape of the item being scrubbed, and thus allows for increased cleaning efficiency.

In one embodiment, the base channels 114 may be spaced across the scrubber base 112 in a honeycomb-like pattern. The diameter of the base channel 114 apertures may be between around 8 and 9 millimeters. The pattern of the base channels 114 across the scrubber base 112 may be such that the base channels are each spaced approximately 1 to 3 millimeters apart from one another.

In one embodiment, the scrubber base 112 is a circular shape to allow for efficient cleaning of the perimeter of a round food container. It will be appreciated that in other embodiments, the scrubber base 112 may be formed in alternative shapes, such as squares, rectangles, or other polygons, in order to efficiently clean food containers of other shapes.

Referring now to FIG. 8, another embodiment of the abrader 116 includes a second abrader ring 122 such that the abrader 116 is secured to the scrubber base 112 via a first abrader ring 118 and a second abrader 122, which prevents the sheet-like abrader 116 from detaching from the scrubber base 112.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

Those skilled in the art will recognize that modifications may be made to the implementation(s) disclosed herein without departing from the scope or spirit of the claimed subject matter. The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the exemplary embodiments and applications illustrated and described, and without departing from the spirit and scope of the following claims.

What has been described above includes examples of aspects of the claimed subject matter. It is, of course, not possible to describe every conceivable combination of components or methodologies for purposes of describing the claimed subject matter, but one of ordinary skill in the art may recognize that further combinations and permutations of the disclosed subject matter are possible. Accordingly, the disclosed subject matter is intended to embrace all such alterations, modifications and variations that fall within the spirit and scope of the appended claims.

Although the subject matter presented herein has been described in language specific to components used therein, it is to be understood that the appended claims are not necessarily limited to the specific component or characteristic thereof described herein. Rather, the specific components and characteristics thereof are disclosed as example forms of implementing the claims.

From the foregoing description of various embodiments of the invention, it will be apparent that modifications may be made therein. It is understood that these embodiments of the invention are exemplifications of the invention only and that the invention is not limited thereto.

What is claimed is:

1. A scrubbing tool comprising:
a top handle, a shaft, a middle handle, and a scrubber base;
the scrubber base forming a plurality of base channels, each base channel extending vertically through the scrubber base; and
an abrader draped around the scrubber base and secured to the scrubber base using a first abrader ring to prevent the abrader from detachment for the scrubber base.

2. The scrubbing tool as recited in claim 1 wherein at least one of the plurality of base channels is dimensioned as a hexagon.

3. The scrubbing tool as recited in claim 1 wherein at least one of the plurality of base channels is dimensioned as a square.

4. The scrubbing tool as recited in claim 1 wherein at least one of the plurality of base channels is dimensioned as a circle.

5. The scrubbing tool as recited in claim 1 wherein at least one of the plurality of base channels is dimensioned as a hexagon.

6. The scrubbing tool as recited in claim 1 wherein the abrader is comprised of a planar, networked pattern of metal rings linked to one another to create a flexible sheet.

7. The scrubbing tool as recited in claim 1 wherein the abrader further comprises a second abrader ring.

8. The scrubbing tool as recited in claim 7 wherein the first abrader ring is located beneath the scrubber base and the second abrader ring is located above the scrubber base.

9. The scrubbing tool as recited in claim 1 wherein the scrubber base is formed from silicone.

10. A scrubbing tool comprising:
a top handle, a shaft, a middle handle, and a scrubber base;
the scrubber base forming a plurality of base channels, each base channel extending vertically through the scrubber base; and
an abrader draped around the scrubber base and secured to the scrubber base using a first abrader ring located beneath the scrubber base and a second abrader ring located above the scrubber base, each of the first and second abrader rings being provided for preventing the abrader from detachment for the scrubber base.

11. The scrubbing tool as recited in claim 10 wherein at least one of the plurality of base channels is dimensioned as a hexagon.

12. The scrubbing tool as recited in claim 10 wherein at least one of the plurality of base channels is dimensioned as a square.

13. The scrubbing tool as recited in claim 10 wherein at least one of the plurality of base channels is dimensioned as a circle.

14. The scrubbing tool as recited in claim 10 wherein at least one of the plurality of base channels is dimensioned as a hexagon.

15. The scrubbing tool as recited in claim 10 wherein the abrader is comprised of a planar, networked pattern of metal rings linked to one another to create a flexible sheet.

16. The scrubbing tool as recited in claim 10 wherein the scrubber base is formed from silicone.

17. A flexible scrubbing tool comprising:
a top handle, a shaft, a middle handle, and a scrubber base;
the scrubber base forming a plurality of base channels, each base channel being dimensioned as a hexagon and extending vertically through the scrubber base;
an abrader draped around the scrubber base and secured to the scrubber base using a first abrader ring located beneath the scrubber base and a second abrader ring located above the scrubber base, each of the first and second abrader rings being provided for preventing the abrader from detachment for the scrubber base; and
the scrubber base being formed from silicone.
